(19) United States
(12) Patent Application Publication
(10) Pub. No.: US 2024/0003022 A1
(43) Pub. Date: Jan. 4, 2024

(54) COMPONENT FOR AN ELECTGROCHEMICAL CELL AND REDOX-FLOW CELL, FUEL CELL AND ELECTROLYZER

(71) Applicant: Schaeffler Technologies AG & Co. KG, Herzogenaurach (DE)

(72) Inventors: Ladislaus DOBRENIZKI, Höchstadt (DE); Mehmet OETE, Nürnberg (DE); Bertram HAAG, Uehlfeld (DE); Jan-Peter Viktor SCHINZEL, Fürth (DE); Jeevanthi VIVEKANANTHAN, Krefeld (DE); Jan Martin STUMPF, Erlangen (DE)

(73) Assignee: Schaeffler Technologies AG & Co. KG, Herzogenaurach (DE)

(21) Appl. No.: 18/037,118

(22) PCT Filed: Oct. 11, 2021
(86) PCT No.: PCT/DE2021/100893

§ 371 Date: May 16, 2023

(30) Foreign Application Priority Data
Nov. 20, 2020 (DE) 102020130693.8

(51) Int. Cl. C25B 11/032; H01M 4/86; H01M 8/18; C25B 11/036; C25B 9/19; C25B 11/052

(52) U.S. Cl. CPC C25B 11/032; H01M 4/8657; H01M 4/8621; H01M 4/8631; H01M 8/188; C25B 11/036; C25B 9/19; C25B 11/052; H01M 2008/1095

(57) ABSTRACT

A component for an electrochemical cell, wherein the component is present in the form of an electrode for a redox-flow cell or in the form of a bipolar plate for a fuel cell or an electrolyzer or in the form of a fluid diffusion layer for an electrolyzer, including a substrate which is formed from a material in the form of a metal sheet and/or an expanded metal grille, wherein the material is formed from a tin-nickel alloy or a tin-silver alloy or a tin-zinc alloy or a tin-bismuth alloy or a tin-antimony alloy. A redox-flow cell, a fuel cell and an electrolyzer are also provided.

### CROSS-REFERENCE TO RELATED APPLICATIONS

This application is the U.S. National Phase of PCT Appln. No. PCT/EP2021/100893, filed Nov. 10, 2021, which claims priority from German Patent Application No. 10 2020 130 693.8, filed Nov. 20, 2020, the entire disclosures of which are incorporated by reference herein.

### TECHNICAL FIELD

The disclosure relates to a component for an electrochemical cell, wherein the component is present in the form of an electrode for a redox flow cell, or in the form of a bipolar plate for a fuel cell or an electrolyzer, or in the form of a fluid diffusion layer for an electrolyzer. The component comprises a substrate formed from a material in the form of a metal sheet and/or an expanded metal grille. The disclosure further relates to a redox flow cell, a fuel cell, and an electrolyzer.

### BACKGROUND

Components in the form of electrodes and redox flow cells equipped therewith, in particular redox flow batteries or flow batteries, are sufficiently known. Redox flow batteries are storage devices for electrical energy, wherein the electrical energy is stored in liquid chemical compounds or electrolytes, what is termed an anolyte and what is termed a catholyte. The electrolytes are located in two reaction chambers separated from one another by an ion exchange membrane. An ion exchange between the anolyte and the catholyte takes place via this membrane, wherein electrical energy is released. The electrical energy released is tapped via one electrode each in contact with the anolyte and the catholyte. The electrolytes are circulated within the reaction chambers by means of pumps, and respectively circulate and flow along the respective facing surface of the membrane. Since the electrolytes can be stored in tanks of any size, the amount of energy stored in the redox flow battery depends only on the size of the tanks used.

Flow battery systems as storage systems provide a sustainable energy supply for stationary and mobile application fields by means of renewable energies. To achieve high efficiencies and power densities, the aim is to have the most compact possible cell designs in battery stacks. However, high power densities pose major challenges regarding the individual components of a battery stack.

WO 2018/145720 A1 describes an electrode unit and a redox flow battery in which the electrode unit is used. Thus, it describes among other things the formation of the electrode unit substrate from a composite material.

WO 2018/146342 A1 discloses various lignin-based electrolyte compositions for use in redox flow batteries.

The publication “A biomimetic high-capacity phenazine-based anolyte for aqueous organic redox flow batteries,” Aaron Hollas et al., Nature energy, Vol. 3, Jun. 2018, pages 508-514, describes anolytes for redox flow batteries based on aqueous “organic” electrolytes or based on aqueous electrolytes with a redox-active organic species. These are becoming increasingly important.

Presently, plate-shaped composites of plastic and graphite are often used as corrosion-resistant substrates for electrodes of redox flow batteries due to the use of strongly basic or acidic electrolytes. These substrates usually have a carbon coating applied to both sides, or there is a carbon felt between the membrane and the electrode that can be flowed through. A total plate thickness of the electrode in a range of about 0.7-1.2 mm is common. Such electrodes are often held in an electrically insulating plastic frame, which entails additional costs for the frame and the assembly process. The size and the manufacturing requirements of such electrodes currently stand in the way of a space-saving and particularly compact geometry of redox flow cells and the rational industrial production thereof.

For the technical background, reference is made to the publication “Engineering aspects of the design, construction and performance of modular redox flow batteries for energy storage”, L. F. Arenas et al., Journal of Energy Storage 11 (2017), pages 119-153.

However, other electrochemical cells, such as fuel cells and electrolyzers, in particular with polymer electrolyte membranes, require corrosion-resistant substrates in the region of the bipolar plates and fluid diffusion layers.

### SUMMARY

The object of the disclosure is to provide a component in the form of an electrode for a redox flow cell or in the form of a bipolar plate for a fuel cell or an electrolyzer or in the form of a fluid diffusion layer for an electrolyzer that can be produced inexpensively. Furthermore, it is the object of the disclosure to provide a redox flow cell, a fuel cell, and an electrolyzer with at least one such component.

The object is achieved for the component comprising a substrate, which is formed from a material in the form of a metal sheet and/or an expanded metal grille, in that the material is formed from a tin-nickel alloy or a tin-silver alloy or a tin-zinc alloy or a tin-bismuth alloy or a tin-antimony alloy.

There may be unavoidable ppm-level impurities present in the tin-nickel alloy or the tin-silver alloy or the tin-zinc alloy or the tin-bismuth alloy or the tin-antimony alloy. It is possible to add at least one other metal with a total content of no more than 1% by weight of all other metals.

A component according to the disclosure in the form of the electrode is electrochemically stable with the active material thereof, in particular in neutral and strongly alkaline conditions, compared to an electrolyte of a redox flow cell. It shows low overvoltages compared to the required reactions in the electrolyte (what is termed catalytic activity) and lowest interfacial resistances comparable to those of gold coatings. The component in the form of the electrode can also be produced inexpensively with just a few production steps.

Depending on the dimensions of an electrode, a bipolar plate, or a fluid diffusion layer, it is advantageous to increase the thickness as the surface area increases to ensure mechanical stability. In principle, sheet metal and expanded metal grilles from a thickness of 0.1 mm can be used for such components. However, it has proven useful if the sheet metal and the expanded metal grille are each designed with a maximum thickness of 5 mm.

In a preferred embodiment of the component, the sheet metal and/or the expanded metal grille has a three-dimensional profile at least in regions. This increases the later available contact surface of the metal sheet or expanded metal grille to a fluid flowing past.

The substrate may comprise only a metal sheet, only an expanded metal grille (possibly in combination with an electrically conductive, fluid-impenetrable support plate, e.g., made of nickel or graphite composite) or a combination of metal sheet and expanded metal grille.

If only one expanded metal grille through which a fluid can flow is provided, this can be rolled up into a coil, stacked in layers one on top of the other, or provided in a single layer.

In the case of a combination of a metal sheet with an expanded metal grille, the expanded metal grille is arranged facing the fluid, wherein there is preferably only a clamping between the metal sheet and the expanded metal grille. However, to simplify subsequent assembly of the component, the expanded metal grille can also be attached to the metal sheet via individual spot welds or glued or soldered to the metal sheet in places.

Preferably, the substrate has a three-dimensional profiling on one side or preferably on both sides, at least in regions, forming a flow field. The introduction of such a flow field into a substrate is possible in a cost-effective manner by embossing or the like. Such a flow field directs the flow of a fluid into defined paths and is equivalent to a three-dimensional structure in the region of the surface of the substrate. It ensures a homogeneous distribution and flow of the fluid on and along the membrane.

The component preferably further comprises a coating which is applied to the substrate, wherein the coating is formed from either
a) carbon or a noble metal or a noble metal alloy or a metal nitride or at least one material from the group consisting of hafnium, niobium, tantalum, bismuth, nickel, tin, tin-nickel alloy, or
b) a homogeneous or heterogeneous solid solution or compound from at least one of the material combinations from the group consisting of: Ir—C, Ir—Ru—C, Ru—C, Ag—C, W—C, Cu—C, Mo—C, Cr—C, Mg—C, Pt—C, Ta—C, Nb—C, wherein a proportion of carbon in the coating is in the range from 35 to 99.99 at. %, or
c) a coating selected to be different from the substrate in terms of a chemical composition, made from a copper-tin alloy or a tin-nickel alloy or a tin-silver alloy or a tin-zinc alloy or a tin-bismuth alloy or a tin-antimony alloy.

Furthermore, traces of hydrogen, nitrogen, boron, fluorine, or oxygen can be present in the cover layer.

A coating according to c) differs from the material of the substrate with regard to the chemical composition, i.e., it can contain the same metals but in a different concentration, or it can contain other metals.

The application of a coating further improves the chemical stability of the component and significantly extends the service life thereof.

The layer preferably has a layer thickness in the range of 2 to 500 nm.

It has proven effective if the coating covers the substrate at least on one side, preferably on both or all sides. In particular in the region of the edges of a metal sheet, uncoated regions or regions with a very small layer thickness can be present. In particular, the coating should cover the substrate in a contact region with an electrolyte of the redox flow cell, i.e., in a region used in direct contact with an anolyte or catholyte.

The coating is preferably formed on the substrate using a PVD process or a combined PVD/PACVD process. It is advantageous in this regard if the coating is deposited as free of pores as possible or at least only has pores with a diameter of less than 0.1 mm to prevent a corroding effect of the fluid on the metallic substrate. However, the coating can also be applied by an alternative coating method, for example galvanically or by thermal spraying.

The coating can also be in the form of a plating if it is made of metal. In metalworking, plating is the one- or two-sided application of one or more metal layer(s) to a different base metal. An inseparable connection is thus achieved through pressure and/or temperature or subsequent heat treatment (e.g., diffusion annealing). The plating can be done in particular by rolling on thin metal foil.

In particular, it has proven useful if the electrode is made of a sheet metal which is provided with a coating on one or both sides, which is formed by plating with one of the metallic materials for the coating mentioned in group a) above, in particular tin.

The object is also achieved for the redox flow cell, in particular redox flow battery, comprising at least one component according to the disclosure in the form of an electrode and at least one electrolyte. In particular, an electrolyte with a pH in the range from 7 to 14 is selected.

The redox flow cell preferably comprises at least two electrodes, a first reaction chamber, and a second reaction chamber, wherein each reaction chamber is in contact with one of the electrodes and wherein the reaction chambers are separated from each other by an ion exchange membrane. The use of the electrode allows small distances to the membrane and thus enables a space-saving design of a redox flow cell.

The electrode is impermeable to the electrolyte, ensuring a problem-free separation of the reaction chambers within a redox flow cell. At the same time, such electrodes have surfaces which, in addition to the high requirements for electrochemical stability, also meet the requirements for low interface resistance and high catalytic activity.

In particular, flow batteries with aqueous electrolytes comprising a redox-active species on the anolyte side are preferred applications for the electrodes according to the disclosure.

Small-sized redox flow batteries can be produced due to the small possible thicknesses of the electrodes, which also have a low manufacturing price. Thus, to form a redox flow battery, preferably more than 10, in particular more than 50 redox flow cells are used in an electrically interconnected manner.

The following anolyte is mentioned here as an example as suitable for a redox flow cell or a redox flow battery:

1.4 M 7,8-dihydroxyphenazine-2-sulfonic acid (short form: DHPS) dissolved in 1 molar sodium hydroxide solution

The following catholyte is mentioned here as an example as suitable for a redox flow cell or a redox flow battery:

0.31 M potassium hexacyanoferrate(II) and 0.31 M potassium hexacyanoferrate(III) dissolved in 2 molar sodium hydroxide solution.

Electrolyte combinations with aqueous electrolytes containing a redox-active organic species on the anolyte side are preferably used to form a redox flow cell or a redox flow battery.

A fuel cell comprising at least one component according to the disclosure in the form of a bipolar plate and at least one polymer electrolyte membrane has proven to be stable over the long term.

Furthermore, an electrolyzer comprising at least one component according to the disclosure in the form of a bipolar plate or a fluid diffusion layer and comprising at least one polymer electrolyte membrane has proven to be stable over the long term.

### BRIEF DESCRIPTION OF THE DRAWINGS

FIGS. 1 through 6 show examples of components in the form of electrodes according to the disclosure and a redox flow cell or a redox flow battery. FIGS. 7 and 8 show an example of a fuel cell and an electrolysis cell of an electrolyzer. In the figures:

FIG. 1 shows an electrode comprising a substrate in a plan view of the substrate plane,

FIG. 2 shows a cross-section through an electrode comprising a coating,

FIG. 3 shows a cross-section through an electrode with a profile,

FIG. 4 shows a cross-section through an electrode comprising a substrate made of a metal sheet and an expanded metal grille,

FIG. 5 shows an electrode with a flux field,

FIG. 6 shows a redox flow cell or a redox flow battery having a redox flow cell,

FIG. 7 shows an electrolyzer in a sectional view, and

FIG. 8 shows a fuel cell stack in a three-dimensional view.

### DETAILED DESCRIPTION

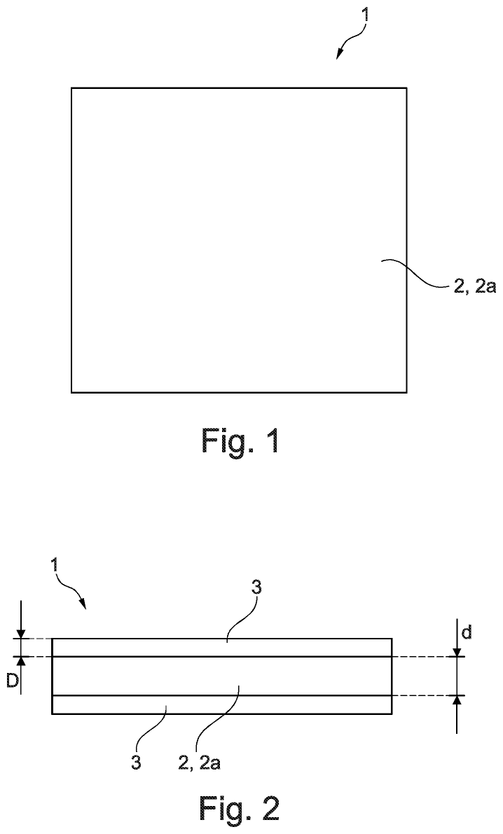

FIG. 1 shows a component 1 in the form of an electrode comprising a substrate 2 in a plan view of the substrate plane. The substrate 2 is formed here from a metal sheet 2a with a thickness of less than 0.5 mm. The metal sheet 2a is made of a tin-silver alloy.

FIG. 2 shows a cross-section through a component 1 in the form of an electrode, comprising a substrate 2 in the form of a metal sheet 2a made of a tin-antimony alloy, which has a coating 3 on both sides. However, the coating 3 can also only be applied to one side of the metal sheet 2a, wherein the coating 3 is intended to cover the substrate 2 at least in a contact region with an electrolyte of a redox flow cell 8 (cf. FIG. 6).

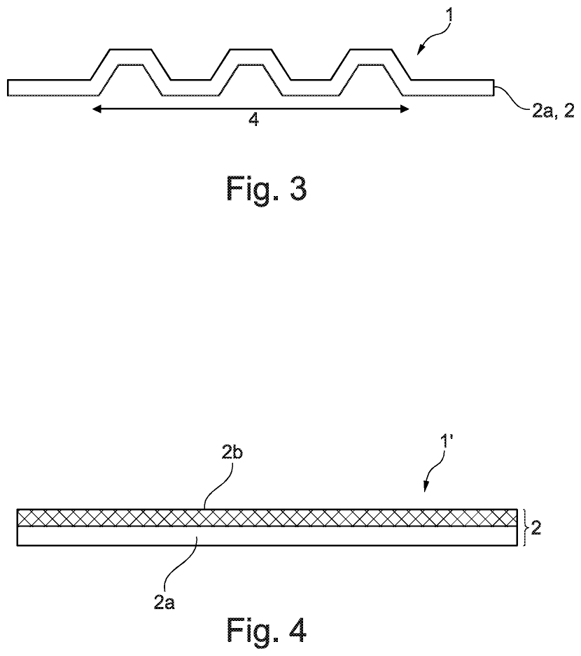

FIG. 3 shows a cross-section through a component 1 in the form of an electrode comprising a substrate 2 in the form of a metal sheet 2a made of tin-bismuth alloy. The metal sheet 2a has a three-dimensional profile 4, which increases the later contact surface of the metal sheet 2a to an electrolyte of a redox flow cell 8.

FIG. 4 shows a cross-section through a component 1′ in the form of an electrode comprising a substrate 2 which comprises a metal sheet 2a and an expanded metal grille 2b. The metal sheet 2a and the expanded metal grille 2b are formed from a tin-silver alloy.

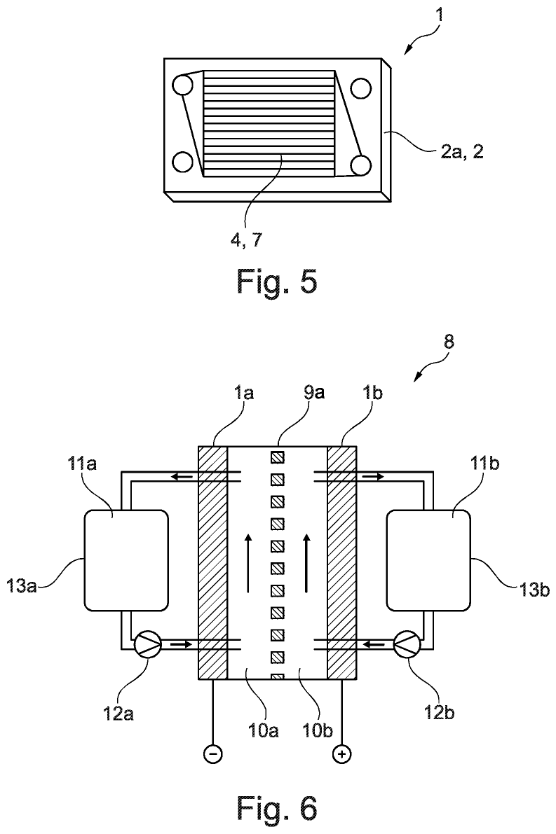

FIG. 5 shows a three-dimensional view of a component 1 in the form of an electrode, comprising a substrate 2 in the form of a metal sheet 2a made of a tin-silver alloy with a profile 4, which forms a flux field 7. In the substrate 2 there is a profile 4 on both sides for forming a flow field 7 in each case, resulting in a three-dimensional structuring of the surface of the electrode against which an electrolyte is to flow in a redox flow cell 8.

FIG. 6 shows a redox flow cell 8 or a redox flow battery, respectively, having a redox flow cell 8. The redox flow cell 8 comprises two components 1a, 1b in the form of electrodes, a first reaction chamber 10a and a second reaction chamber 10b, wherein each reaction chamber 10a, 10b is in contact with one of the electrodes. The reaction chambers 10a, 10b are separated from one another by an ion exchange membrane 9a. A liquid anolyte 11a is pumped from a tank 13a into the first reaction chamber 10a via a pump 12a and is fed through between the component 1a and the ion exchange membrane 9a. A liquid catholyte 11b is pumped from a tank 13b into the second reaction chamber 10b via a pump 12b and is fed through between the component 1b and the ion exchange membrane 9a. Ion exchange occurs across the ion exchange membrane 9a, wherein electrical energy is released due to the redox reaction at the electrodes.

FIG. 7 shows an electrolysis cell 20 of an electrolyzer comprising a polymer electrolyte membrane 9 which separates an anode side A and a cathode side K from one another. A catalyst layer 21a, 21b, each comprising a catalyst material and a fluid diffusion layer 22a, 22b, is arranged adjacent to the catalyst layer 21a, 21b on both sides of the polymer electrolyte membrane 9. The fluid diffusion layers 22a, 22b are each arranged adjacent to an electrically conductive plate 24a, 24b, wherein the fluid diffusion layers 22a and 22b are formed from an expanded metal 2b, 2b′ made of a tin-silver alloy. The plates 24a, 24b each have flow channels 23a, 23b on the sides thereof facing the fluid diffusion layers 22a, 22b to improve the supply of reaction medium (water) and a removal of reaction products (water, hydrogen, oxygen).

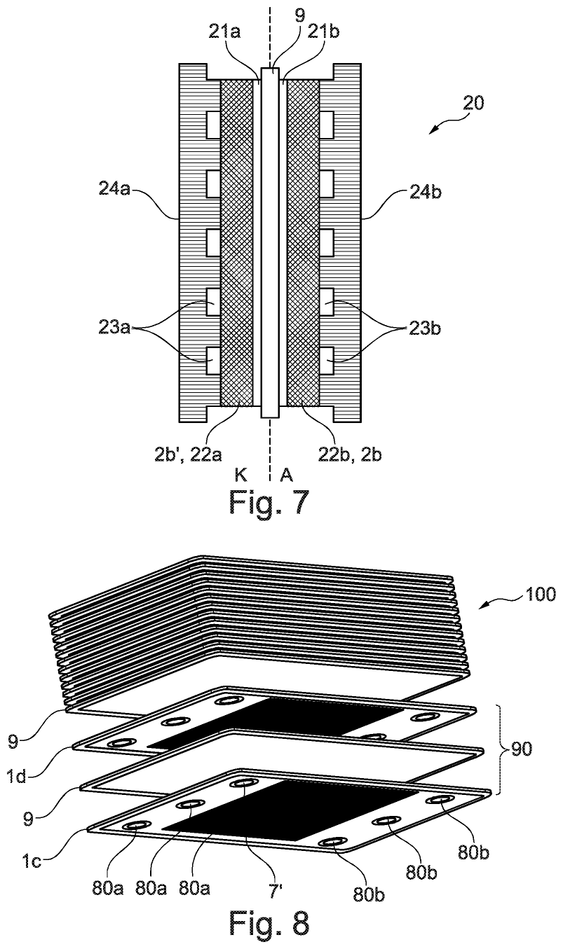

FIG. 8 schematically shows a fuel cell stack 100 comprising multiple fuel cells 90. Each fuel cell 90 comprises a polymer electrolyte membrane 9 adjacent to both sides of components 1c, 1din the form of bipolar plates. Each bipolar plate has a tin-silver alloy substrate. The bipolar plate has an inflow region with openings 80a and an outlet region with further openings 80b, which are used to supply a fuel cell (90) with process gases and coolant and to remove reaction products from the fuel cell (90) and coolant. The bipolar plate also has a gas distribution structure 7′ on each side, which is provided for contact with the polymer electrolyte membrane 9.

### LIST OF REFERENCE SYMBOLS

1, 1′, 1a, 1b, 1c, 1d Component
2 Substrate
2a Sheet metal
2b, 2b′ Expanded metal grille
3 Coating
4 Profile
7 Flux field
7′ Gas distribution structure
8 Redox flow cell or redox flow battery
9 Polymer electrolyte membrane
9a Ion exchange membrane
10a First reaction chamber
10b Second reaction chamber
11a Anolyte
11b Catholyte
12a, 12b Pump
13a, 13b, 13c Tank
20 Electrolysis cell of an electrolyzer
21a, 21b Catalyst material
22a, 22b Fluid diffusion layer
23a, 23b Flow channels
24a, 24b Electrically conductive plate
80a, 80b Openings
90 Fuel cell
100 Fuel cell stack
A Anode side
K Cathode side
d Thickness of sheet metal or expanded metal
D Thickness of the coating

1. A component for an electrochemical cell, the component comprising:
an electrode for a redox-flow cell or a bipolar plate for a fuel cell or an electrolyzer or a fluid diffusion layer for an electrolyzer, comprising a substrate formed from a material comprising at least one of a metal sheet or an expanded metal grille; and
the material is formed from a tin-nickel alloy or a tin-silver alloy or a tin-zinc alloy or a tin-bismuth alloy or a tin antimony alloy.

2. The component according to claim 1, wherein the at least one of the metal sheet or the expanded metal grille are each designed with a maximum thickness of 5 mm.

3. The component according to claim 1, wherein the at least one of the metal sheet or the expanded metal grille has a three-dimensional profile at least in regions.

4. The component according to claim 1, further comprising a coating which is applied to the substrate, the coating is either
a) carbon or a noble metal or a noble metal alloy or a metal nitride or at least one material from the group consisting of hafnium, niobium, tantalum, bismuth, nickel, tin, tin-nickel alloy, or
b) a homogeneous or heterogeneous solid solution or compound from at least one of the material combinations from the group consisting of: Ir—C, Ir—Ru—C, Ru—C, Ag—C, W—C, Cu—C, Mo—C, Cr—C, Mg—C, Pt—C, Ta—C, Nb—C, wherein a proportion of carbon in the coating is in a range from 35 to 99.99 at. %, or
c) a coating selected to be different from a material composition of the substrate that is made from a copper-tin alloy or a tin-nickel alloy or a tin-silver alloy or a tin-zinc alloy or a tin-bismuth alloy or a tin-antimony alloy.

5. The component according to claim 4, wherein the coating has a layer thickness in a range of 2 to 500 nm.

6. The component according to claim 5, wherein the component is the electrode for the redox flow cell, and the coating covers the substrate at least in a contact region to an electrolyte of the redox flow cell.

7. A redox flow cell, comprising:
at least one electrode comprising a substrate formed from a material comprising at least one of a metal sheet or an expanded metal grille in which the material is formed from a tin-nickel alloy or a tin-silver alloy or a tin-zinc alloy or a tin-bismuth alloy or a tin antimony alloy, and
at least one electrolyte with a pH in a range from 7 to 14.

8. The redox flow cell according to claim 7, wherein the at least one electrode comprises at least two electrodes, a first reaction chamber and a second reaction chamber, wherein each of the reaction chambers is in contact with one of the electrodes and the reaction chambers are separated from each other by an ion exchange membrane.

9. A fuel cell comprising:
at least one bipolar plate comprising a substrate formed from a material comprising at least one of a metal sheet or an expanded metal grille in which the material is formed from a tin-nickel alloy or a tin-silver alloy or a tin-zinc alloy or a tin-bismuth alloy or a tin antimony alloy, and
at least one polymer electrolyte membrane.

10. An electrolyzer comprising:
at least one bipolar plate or a fluid diffusion layer comprising a substrate formed from a material comprising at least one of a metal sheet or an expanded metal grille in which the material is formed from a tin-nickel alloy or a tin-silver alloy or a tin-zinc alloy or a tin-bismuth alloy or a tin antimony alloy, and
at least one polymer electrolyte membrane.

11. The redox flow cell according to claim 7, wherein the at least one of the metal sheet or the expanded metal grille are each designed with a maximum thickness of 5 mm.

12. The redox flow cell according to claim 7, wherein the at least one of the metal sheet or the expanded metal grille has a three-dimensional profile at least in regions.

13. The redox flow cell according to claim 7, further comprising a coating which is applied to the substrate, the coating is either
a) carbon or a noble metal or a noble metal alloy or a metal nitride or at least one material from the group consisting of hafnium, niobium, tantalum, bismuth, nickel, tin, tin-nickel alloy, or
b) a homogeneous or heterogeneous solid solution or compound from at least one of the material combinations from the group consisting of: Ir—C, Ir—Ru—C, Ru—C, Ag—C, W—C, Cu—C, Mo—C, Cr—C, Mg—C, Pt—C, Ta—C, Nb—C, wherein a proportion of carbon in the coating is in a range from 35 to 99.99 at. %, or
c) a coating selected to be different from a material composition of the substrate that is made from a copper-tin alloy or a tin-nickel alloy or a tin-silver alloy or a tin-zinc alloy or a tin-bismuth alloy or a tin-antimony alloy.

14. The redox flow cell according to claim 13, wherein the coating has a layer thickness in a range of 2 to 500 nm.

15. The fuel cell according to claim 9, wherein the at least one of the metal sheet or the expanded metal grille are each designed with a maximum thickness of 5 mm.

16. The fuel cell according to claim 9, wherein the at least one of the metal sheet or the expanded metal grille has a three-dimensional profile at least in regions.

17. The fuel cell according to claim 9, further comprising a coating which is applied to the substrate, the coating is either
a) carbon or a noble metal or a noble metal alloy or a metal nitride or at least one material from the group consisting of hafnium, niobium, tantalum, bismuth, nickel, tin, tin-nickel alloy, or
b) a homogeneous or heterogeneous solid solution or compound from at least one of the material combinations from the group consisting of: Ir—C, Ir—Ru—C, Ru—C, Ag—C, W—C, Cu—C, Mo—C, Cr—C, Mg—C, Pt—C, Ta—C, Nb—C, wherein a proportion of carbon in the coating is in a range from 35 to 99.99 at. %, or
c) a coating selected to be different from a material composition of the substrate that is made from a copper-tin alloy or a tin-nickel alloy or a tin-silver alloy or a tin-zinc alloy or a tin-bismuth alloy or a tin-antimony alloy.

18. The fuel cell according to claim 17, wherein the coating has a layer thickness in a range of 2 to 500 nm.

19. The electrolyzer according to claim 10, wherein the coating has a layer thickness in a range of 2 to 500 nm.

20. The electrolyzer according to claim 10, wherein the at least one of the metal sheet or the expanded metal grille are each designed with a maximum thickness of 5 mm.
